(19) United States
(12) Patent Application Publication
(10) Pub. No.: US 2014/0181158 A1
(43) Pub. Date: Jun. 26, 2014

(54) MEDIA FILE SYSTEM WITH ASSOCIATED METADATA

(71) Applicants: William Herz, Sunnyvale, CA (US); Emmanuel Marquez, Sunnyvale, CA (US)

(72) Inventors: William Herz, Sunnyvale, CA (US); Emmanuel Marquez, Sunnyvale, CA (US)

(21) Appl. No.: 13/723,397

(22) Filed: Dec. 21, 2012

(51) Int. Cl. G06F 17/30

(52) U.S. Cl. CPC G06F 17/3012
USPC 707/821

(57) ABSTRACT

In a system that includes a selection device, a method is provided that includes playing a media file with the system, and adjusting one or more media playback settings based on metadata associated with the media file.

### BACKGROUND

1. Field

This disclosure relates generally to computing systems and software, and more particularly to systems capable of playing media and methods of using the same.

2. Description of the Related Art

Adjusting display settings based on content is a longstanding challenge and remains unresolved by display manufacturers. TV manufacturers have tended to rely on automatic or dynamic settings, which are based on pixels rather than user intervention. The advent of the internet has brought new dimensions to the problem, since video content may now be located everywhere and displayed anywhere. Consequently, tailoring settings to content has become a bigger, unresolved problem. It is a persistent challenge to adjust a video for preferred playback mode given the ever increasing sources of content, file formats, video codecs, driver version and different display devices, such as laptops, TVs, tablets, desktop PCs and smartphones.

Display manufacturers currently offer a set of adjustable display settings. However, the numbers of settings are minimal and are not based on specific content. The adjustments or settings exist for certain filters in a dynamic version (e.g. dynamic brightness and contrast depending on the environment). But conventional systems do not allow adjustments on a per playback, channel, or even scene basis. Adjustments are only made by the display environment (e.g. set top box, console, HDTV etc.). Conventional display environments do not address content specifics like time, type of content, formats etc. Content creators may adjust the original content settings for a very specific case & playback experience. Some graphics processing unit (GPU) manufacturers mirror the display option within extended possibilities but without the possibility to journal (replicate prior insightfully established settings) those settings within specific content.

Some conventional video display systems enable the user to make various settings changes. These changes are typically input by the user via one or more dialog boxes or on-screen menus. Depending on the sophistication of the user, these changes may involve navigating many dialog boxes and menus and selecting many more options therein. Some such settings changes may only be useful for particular types of media, displays or devices. If lost, the recreation of such settings changes may prove laborious indeed. Nothing is better than a human tuning the processing for an optimal quality result. The embodiments virtualize the expert human tuning instead of adaptive pixel processing by a machine whose permutations are insurmountable.

The embodiments are directed to overcoming or reducing the effects of one or more of the foregoing disadvantages.

### SUMMARY OF EMBODIMENTS

In accordance with an embodiment, in a system having a selection device, a method is provided that includes playing a media file with the system, and adjusting one or more media playback settings based on metadata associated with the media file.

In accordance with an embodiment, a method is provided that includes associating metadata with a media file, wherein the metadata is usable by a media player to adjust one or more playback settings of the media file.

In accordance with an embodiment, a system for playing a media file is provided. The system includes metadata associated with the media file, and a processor programmed to adjust one or more media playback settings based on the metadata.

In accordance with an embodiment, a computer readable medium is provided that has computer readable instructions for performing a method that includes playing a media file with a system, and adjusting one or more media playback settings based on metadata associated with the media file.

In accordance with an embodiment, in a system having a selection device, a method is provided that includes playing a media file with the system and adjusting one or more media play or record settings based on metadata associated with a play or record environment.

### BRIEF DESCRIPTION OF THE DRAWINGS

The foregoing and other advantages of the embodiments will become apparent upon reading the following detailed description and upon reference to the drawings in which:

FIG. 1 is a schematic view of an exemplary embodiment of a video playback system that may be used with an exemplary software interface;

FIG. 2 is a schematic view of various exemplary video playback devices;

FIG. 3 is a schematic view of some exemplary video media sources;

FIG. 4 is a schematic view of an exemplary computing system of video playback as well as a schematic view of a number of exemplary types of user input techniques, according to some embodiments; and

FIGS. 5A and 5B are a flow chart illustrating some exemplary process steps incorporating video/audio metadata to manipulate media playback behavior according to some embodiments.

### DETAILED DESCRIPTION OF SPECIFIC EMBODIMENTS

Various embodiments of a media file playback system and media control software are disclosed. The media control software is operable to use metadata associated with a media file, whether stored or streamed, to adjust one or more media playback settings based on the metadata. The metadata can provide adjustments to playback settings tailored to content, device and/or user. The metadata can be in the form of a file stored in a local database or a remote database, such as a social media service. In this way users may create and share metadata associated with the media file. Additional details will now be described.

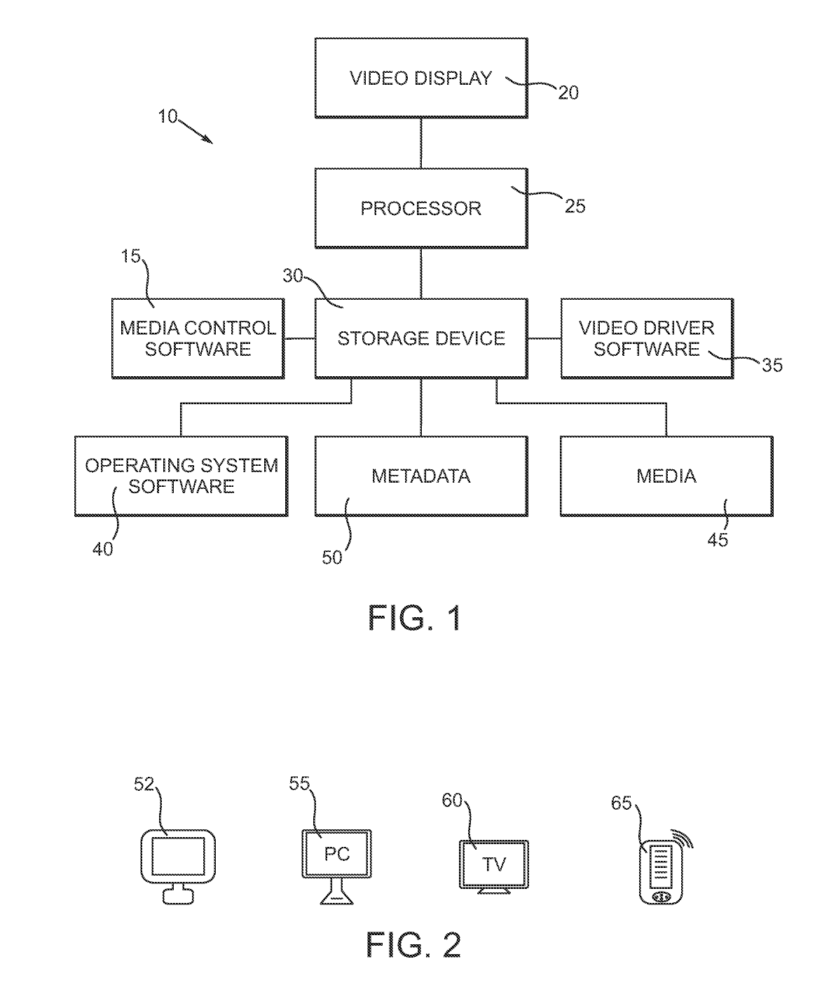

In the drawings described below, reference numerals are generally repeated where identical elements appear in more than one figure. Turning now to the drawings, and in particular to FIG. 1 therein is shown a schematic view of an exemplary embodiment of a computer system 10 that may be used with media control software 15 that is designed to enable the user to manipulate various aspects of video playback and other features. The media control software 15 may take on a variety of forms. One exemplary embodiment may be an application presently known as Video Power Pack (VPP) available from Advanced Micro Devices, Inc. Other examples include video preprocessing for transcoding or encoding for wireless displays, video conferencing or others. The computer system 10 may take on a great variety of configurations and include various features. In this illustrative embodiment, the computer system 10 may include some type of video display 20, a processor 25, at least one storage device 30, the aforementioned media control software 15, optional video driver software 35, operating system software 40, some form of media 45 and metadata 50.

The video display 20 may take on a great variety of configurations, such as a monitor, an integrated video screen in a computer, handheld device or other device, a television, or the like. The processor 25 may be an integrated circuit dedicated to video processing, a microprocessor, graphics processing unit (GPU), an accelerated processing unit (APU) that combines microprocessor and graphics processor functions, an application specific integrated circuit or other device. An exemplary APU may include fixed function cores for compression, decompression, pre-imposed or post-imposed processing tasks or others. Indeed, the processor 25 may consist of multiple examples of such integrated circuits operating in parallel or otherwise.

The storage device 30 is a computer readable medium and may be any kind of hard disk, optical storage disk, solid state storage device, ROM, RAM or virtually any other system for storing computer readable media. The optional video driver software 35 may be used depending upon the capabilities of the operating system software 40 and the overall capabilities of the processor 25. The media control software 15 is intended to be platform and operating system neutral. Thus, the operating system software 40 may be virtually any type of software design to facilitate the operation of the processor 25 and a storage device 30. Windows®, Linux, iOS or more application specific types of operating system software may be used or the like. The types of media 45 will be described in conjunction with a subsequent figure. It should be understood that the media control software 15, the optional video driver software 35 and the operating system 40 may be resident on the storage device 30 or stored in some other location and transferred to the video playback device 10 as necessary by way of some form of network connection or other type of delivery system.

FIG. 2 is a schematic representation of a few exemplary types of computer systems 10 capable of displaying video. For example, a video monitor 52, a personal computer 55, a television 60 or a mobile computing device like a handheld device 65 (e.g., a smart phone), other personal digital assistant or even a remote control with a display, may be used. The external monitor 50 may be connected to some other type of video delivery system, such as an optical disk player, a computer, a set top box or the like. The same is true for the personal computer 55 and the TV 60. It should be understood that various levels of integration may be implemented to combine features. For example, the TV 60 may include an integrated optical disk player, hard drive or the like and even incorporate the media control software 15 and operating system software 40. In another example, the smart phone 65 may integrate all the features of FIG. 1 in a single enclosure. A computer system 10 could be embodied as a conventional desktop, notebook or server computer system, mobile (e.g., handheld or palm/pad type) computer system, intelligent television, set top box, computer kiosk or any other computing platform. Thus, the terms “computer system” as used herein contemplates various levels of device integration as well as embedded systems, x86-based, or other architecture.

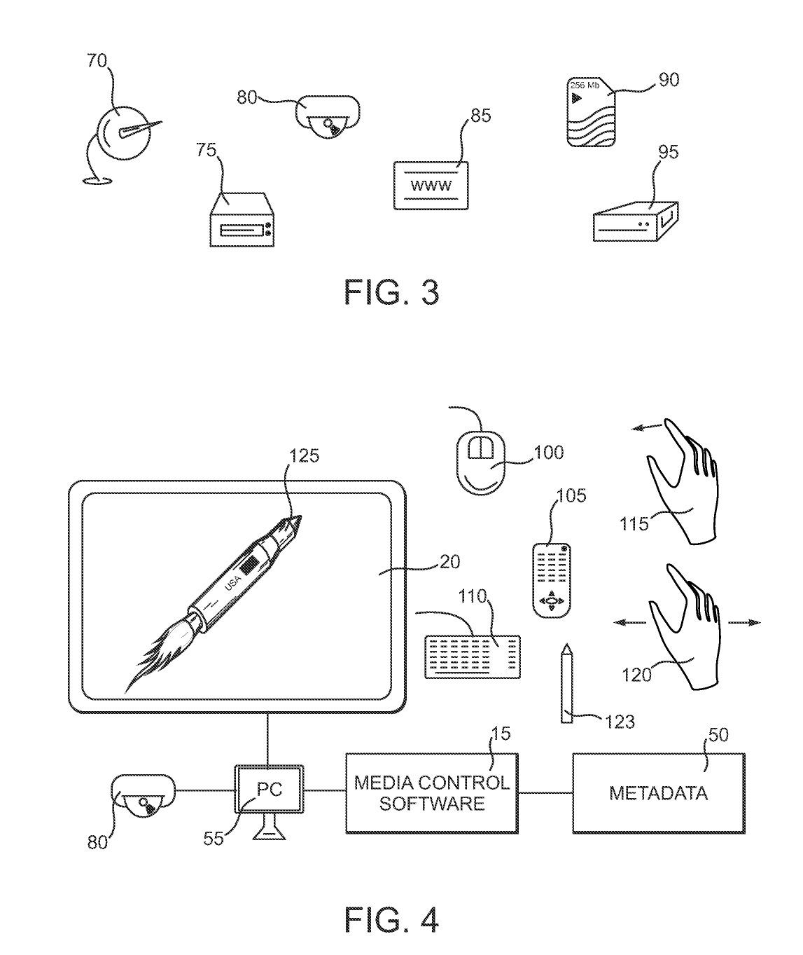

FIG. 3 depicts schematically some of the types of media anticipated that may be used with the video playback system 10 depicted in FIG. 1. Examples include media supplied by satellite tuner 70, cable set top box 75, optical disk player 80, internet streaming 85, a removable storage device 90 or a hard drive 95. These represent just a few examples of the types of media that may be used to deliver video signals to the video processor and thus the video display depicted in FIG. 1.

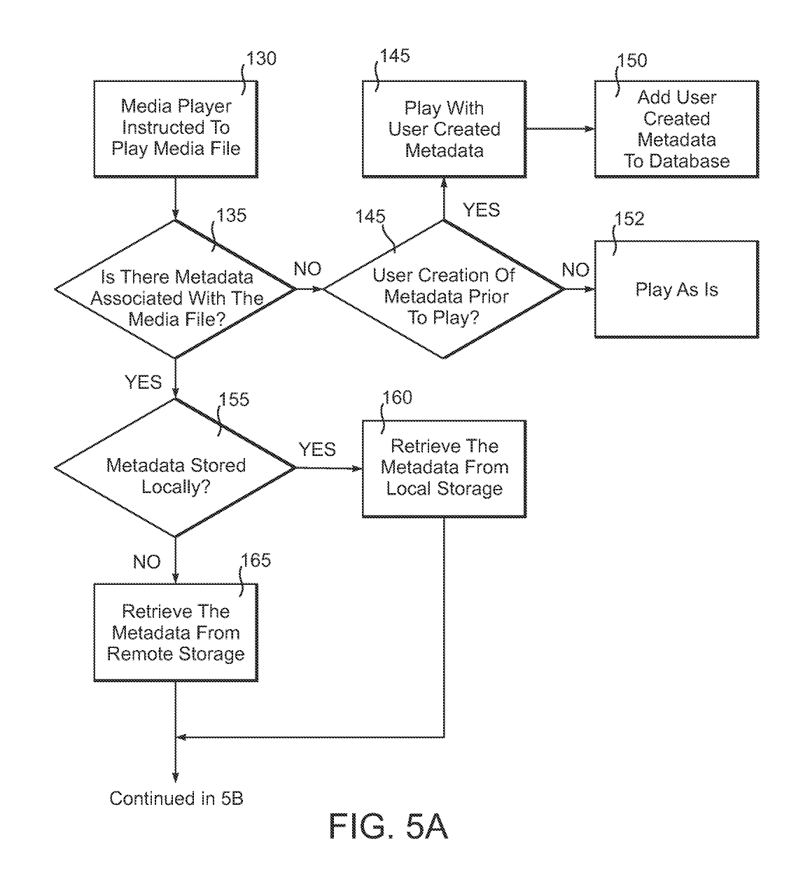

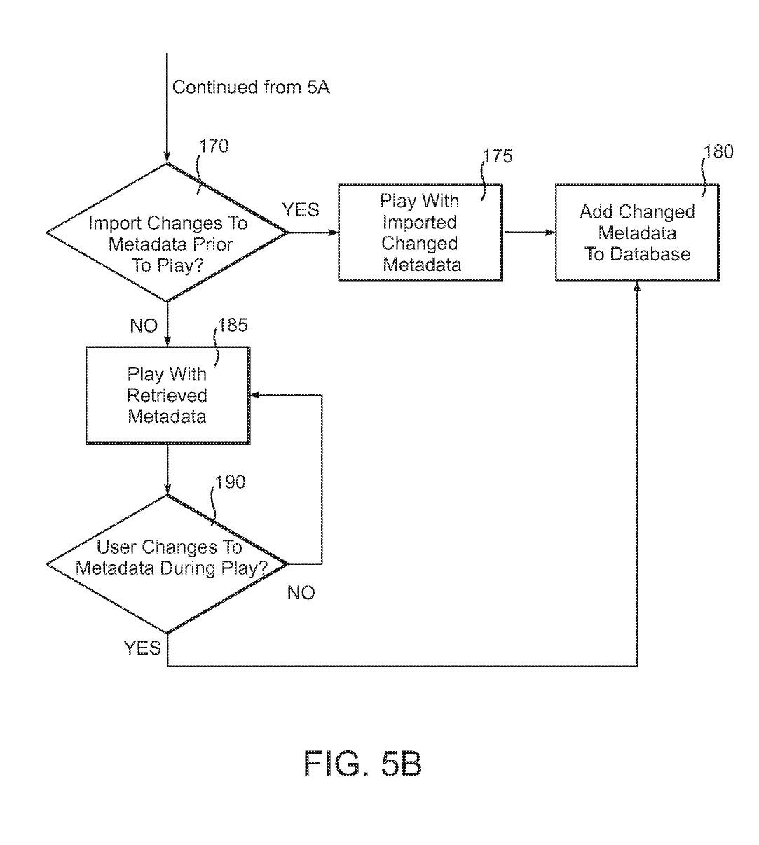

The operation of the media control software 15 depicted schematically in FIG. 1 will now be described in conjunction with FIGS. 4-5 and initially to FIG. 4. FIG. 4 depicts an example of a video display 20, which in this case is an external video display connected to a personal computer 55 and an optical disk player 80 that provides the requisite video media. The optical disk player 80 is connected to or part of a personal computer 55 that is connected to the display 20. As noted elsewhere herein, however, the various components that ultimately provide the video display can take on a great number of configurations. Assume for the purposes of this illustration that the media control software 15 is loaded on a computer readable medium in or connected to the computer 55. The media control software 15 may be provided with the capability to receive user input in a variety of ways. For example, input may be by way of selection devices, such as a mouse 100, a remote control 105, a keyboard 110, human touch 115, human gesture 120, digital pen 123, or other. The human gesture 120 may be performed by hand motion or by way of motion with the remote control 105 or similar device, by eye movement, voice command or other. Of course, user input may be by any combination of the foregoing techniques. The media control software 15 may be launched in a variety of ways. In one example, the media control software 15 may operate as a background service that launches on system start up. In other options, the media control software 15 may be manually launched by user selection of a menu or icon, or automatically launched upon start up of a media play program.

Assume for the purposes of the following discussion that the video display 20 is touch enabled so that user input may be by touch 115 and that the optical disk media 80 is activated and video is being displayed on the display 20. In this figure, an example video file entitled Rocketmovie.mov, which shows a simple illustration of a rocket 125 at boost phase, is displayed on the video display 20, where .mov file extension is a hypothetical media file extension type. The media control software 15 is operable to store/retrieve the metadata 50, which functions as information that may be settings for virtually any kind of reproducible video-audio-video/audio files. Using the metadata 50, it is possible for a user to store a huge variety of video settings preferences per video file. Various levels of settings granularity are envisioned, including settings for an entire video/audio file, settings for individual scenes, settings for different users, settings for a given scene or number of frames or others. The metadata 50 can be retrieved and applied to the content at a future time as well as be shared with other users either by direct network connections, such as peer to peer, or by way of social media sites, such as Facebook® or others. It should be understood that the addition of metadata 50 to any kind/type of reproducible video-audio-video/audio files could be done by, for example, the media control software 15, by media player hardware, firmware on for example a cable box or other player or by way of embedded application code in a device such as a smart television. The metadata 50 may exist as a separate file or as embedded information within the media file itself. The metadata 50 may be created in a variety of ways, such as by having the media control software 15 store user inputs for settings in a variety of formats like html, text files or others.

One exemplary method for the system 10 depicted in FIG. 1 or the arrangement depicted in FIG. 4 to incorporate the metadata 50 to control the playback behavior of the media file may be by de-multiplexing a media stream into component portions: 1) audio; 2) video; and 3) data and thereafter incorporating the metadata 50 into, for example, the processing of the video and/or audio portions of the de-multiplexed stream. The metadata 50 will typically be stored in a database that may be stored locally or remotely. The storage and/or retrieval of the metadata 50 may be accomplished by any of the aforementioned sources. The media control software 15 may be operable to provide a set of plugins that enable the sharing of the local user database within a social network. In this circumstance, the user may upload and synchronize a local database to a social media network account that can be accessed by others using a social network account and credential logon.

The following table shows some typical hypothetical pieces of data and metadata 50 information that may be utilized by the media control software 15 for the hypothetical video file Rocketmovie.mov:

| File Name | Data | Metadata | |
|---|---|---|---|
| Rocketmovie.mov | File size | Settings 1 | Time Stamp 1 |
| | Date last modified | Settings 2 | Time Stamp 2 |
| | by operating system | Settings 3 | Time Stamp 3 |
| | File type | . | . |
| | Bit rate | . | . |
| | Frame Rate | . | . |
| | Duration | Settings n | Time Stamp n |
| | URL file property | | |
| | (for online file) | | |

The items of information under the Data column will typically be aggregated by the system 10 in FIG. 1 or 4, or embedded in the cases of optical disk formats. A non-exhaustive list of the types of Settings 1 . . . Settings n that may be included in the metadata 50 under the Metadata column includes stabilization, motion compensated frame rate conversion, super resolution (scaling), noise reduction, contour reduction, detail enhancement, color enhancement, standard color adjustments, flesh tone enhancement, video gamma, deinterlacing, pulldown or cadence correction, edge enhancement, denoise, split screen modes, enforce smooth video playback, mosquito noise reduction, deblocking, brighter whites, red, green, blue stretch, dynamic contrast enhancement, color range and color space, video pop, deblurring and 2D to 3D conversion. In addition, the metadata 50 may include specifics of driver, renderer and media source. In an exemplary embodiment, the Settings 1 . . . Settings n of the metadata 50 may be generated and stored in a journal presets file in VPP or other application. The Settings 1 . . . Settings n of the metadata 50 may be time stamped with time stamps Time Stamp 1 . . . Time Stamp n for purposes of processing based on time stamp within content.

The media control software 15 may be operable to generate a unique signature for a media file, such as the Rocketmovie.mov file, that is based on available file information such as size, date modified date created name, etc. and is also operable to link the metadata 50, if any, with the unique signature for the file for playback purposes. It may be useful to utilize unique signatures for a given media file for playback purposes since there may exist several versions of a given media file. For example, the Rocketmovie.mov may exist in different versions, some that are full length, some edited for time, and still others that include trailer information and other variations or with varying artifacts.

An exemplary method for utilizing the metadata 50 may be understood by referring to FIG. 1, and to FIG. 5 (FIGS. 5A and 5B), which is a flow chart of some exemplary process steps. The following description assumes the usage of the media control software 15. However, and as noted above, other code or hardware may be used to implement the functionality. At step 130, the media player is instructed to play a media file. For example, the system 10 may be instructed by the user to play a certain media file, say the Rocketmovie.mov described above. This may involve selection of a file by way of a selection device, such as a mouse or touch input, for example. The media control software 15 itself may be responsible for playing the media or it may interact with separate media player code (such as video player software) to eventually play the media. Next and at step 135, a determination is made as to whether or not there is any metadata 50 associated with the media file. This determination may be made by the media control software 15, and can involve the examination of the media file, its unique signature and any association with metadata 50. If there is no metadata 50 currently associated with media file, then at step 140, the media control software 15 determines if there will be user-created metadata 50 prior to playing the media file. This may involve, for example, a prompt presented to the user to create metadata 50 for that particular media file play session tailored to that user or another user prior to playing the media file. The user may elect to create metadata 50 at this stage and then at step 145 the media file is played with the user-created metadata 50. Finally, at step 150 the user created metadata 50 may be added to the metadata database. If, however, the user declines to create metadata 50, the media file is played as is at step 152. If however at step 135, the media control software 15 determines that there is metadata 50 associated with the media file then the media control software 15 determines at step 155 whether the metadata is stored locally or not. If the media control software 15 determines that the metadata 50 is stored locally at step 155, then at step 160 the media control software 15 retrieves the metadata 50 from the local storage. If however at step 155 the media control software 15 determines that the metadata 50 is not stored locally then at step 165, the media control software 15 retrieves the metadata 50 from remote storage. This may involve accessing the metadata 50 from a dedicated remote server, by way of a social media site or other remote storage system. The remotely-stored metadata 50 may have been created by the user in question, by other users, by content creators or even by media player vendors, graphics devices vendors or other vendors. Such vendors may create metadata 50 that is tailored to their particular products or product standards.

With the retrieved metadata 50 in hand at step 170, the media control software 15 determines if the user intends to import any changes to the metadata 50 prior to playing the media file. Again this may be facilitated by way of one or more types of prompts presented to the user to import any changes to the metadata 50 prior to playing the media file. For example, the user may be prompted to import changes to the metadata 50 that had been provided by another user to the existing user by way of a social media site or other direct networking linkage between the two users. The imported metadata 50 may have also been created by the user in question, by other users, by content creators or even by media player vendors, graphics devices vendors or other vendors. Such vendors may create metadata 50 that is tailored to their particular products or product standards. If the user does elect to import changes to the metadata 50 prior to play, then at step 175 the media control software 15 plays the media file with the imported, changed metadata 50. Finally at step 180, the media control software 15 may add the changed metadata 50 to the database. Conversely, if at step 170 the user elects not to import changes to the metadata 50 prior to play then at step 185, the media is played merely with the retrieved metadata 50. Of course, the user may elect to change the metadata 50 during play at step 190, say by changing one or more settings and these changes may be added to the database in a return to step 180.

As just described, media play may involve multiple metadata 50 storage and retrieval steps. If space and bandwidth savings are preferred, the metadata 50 could be compressed and decompressed using lossless file compression/decompression methods. Note that the user could, at virtually any stage, share the metadata 50 with others via social media sites. The metadata 50 described herein, and used for playback or recording, may be associated with an environment, such as a particular room, media player, display, network bandwidth, etc. This association may be in addition to or in lieu of association with a media file.

As noted above, the implementation of the software embodiments disclosed herein is not dependent upon a particular programming language. In one embodiment suitable for use in a Windows® environment, the .NET framework version 4.0 client profile for 32-bit or 64-bit systems along with an AMD multi-media driver library may be used to implement the media control software 15 depicted in FIGS. 1 and 4. It is desirable for the media control software 15 to utilize the multi-media driver library in order to take advantage of the video acceleration capabilities of, for example, the video processor 25 depicted in FIG. 1.

While the embodiments may be susceptible to various modifications and alternative forms, specific embodiments have been shown by way of example in the drawings and have been described in detail herein. However, it should be understood that the embodiments are not intended to be limited to the particular forms disclosed. Rather, the embodiments are to cover all modifications, equivalents and alternatives falling within the spirit and scope of the invention as defined by the following appended claims.

What is claimed is:

1. In a system having a selection device, a method comprising:
playing a media file with the system; and
adjusting one or more media playback settings based on metadata associated with the media file.

2. The method of claim 1, comprising retrieving the metadata from a local database.

3. The method of claim 1, comprising retrieving the metadata from a remote database.

4. The method of claim 3, wherein the remote database is accessible from a social media service.

5. The method of claim 1, comprising creating the metadata locally.

6. The method of claim 5, comprising storing the metadata to a remote database.

7. The method of claim 5, comprising storing the metadata in a local database.

8. The method of claim 1, comprising changing the metadata prior to playing the media file.

9. The method of claim 8, comprising exporting the changed metadata to a remote database.

10. The method of claim 1, wherein the metadata is stored in a compressed format.

11. The method of claim 1, wherein the playback settings are selected from the group consisting of video display settings and audio settings.

12. The method of claim 1, wherein the metadata is user specific.

13. The method of claim 1, wherein the metadata is created by logging and storing user inputs.

14. A method, comprising:
associating metadata with a media file; and
wherein the metadata being usable by a media player to adjust one or more playback settings of the media file.

15. The method of claim 14, comprising creating the metadata.

16. The method of claim 15, comprising storing the metadata on a database accessible by other users.

17. The method of claim 15, comprising storing the metadata on a local database.

18. The method of claim 14, wherein the metadata is stored on a local database.

19. The method of claim 14, wherein the metadata is stored on a remote database.

20. The method of claim 19, wherein the remote database is accessible from a social media service.

21. The method of claim 14, wherein the metadata is stored in a compressed format.

22. The method of claim 14, wherein the playback settings are selected from the group consisting of video display settings and audio settings.

23. The method of claim 14, wherein the metadata is created by logging and storing user inputs.

24. A system for playing a media file, comprising:
metadata associated with the media file; and
a processor programmed to adjust one or more media playback settings based on the metadata.

25. The system of claim 24, wherein the system comprises a television, a computer, or a mobile computing device.

26. A computer readable medium having computer readable instructions for performing a method comprising:
playing a media file with a system; and
adjusting one or more media playback settings based on metadata associated with the media file.
